(19) United States
(12) Patent Application Publication
(10) Pub. No.: US 2026/0348211 A1
(43) Pub. Date: Nov. 5, 2026

(54) Door Hinge

(71) Applicant: SROOC Holdings, LLC, Waco, TX (US)

(72) Inventor: Jerrod Chance Cook, Lorena, TX (US)

(21) Appl. No.: 19/739,561

(22) Filed: Jul. 13, 2026

Related U.S. Application Data
(63) Continuation of application No. 18/155,719, filed on Jan. 17, 2023, now Pat. No. 12,680,356.
Application No. 18/155,719 is a continuation of application No. 29/797,856, filed on Jul. 2, 2021, now Pat. No. D1046596.
(60) Provisional application No. 63/266,897, filed on Jan. 18, 2022.

(51) Int. Cl. E05D 3/12; B60J 5/04; E05B 85/04; E05D 5/02

(52) U.S. Cl. CPC E05D 3/127; B60J 5/0487; E05D 5/0207; E05B 85/04; E05Y 2900/531

(57) ABSTRACT

A method and apparatus for providing a replacement door to a UTV/ATV to replace a mesh door with a panel door employs a hinge member that is mounted to the UTV/ATV after removal of the mesh door. The mesh door and other components are removed from the UTV/ATV. The hinge member includes a first and second angled flanges adapted to mount to the frame of the UTV/ATV after removal of the mesh door. Striker components are mounted to the frame to engage the door latches. The replacement panel door mounts to the hinge member and provides panel doors to the UTV/ATV.

This application is a continuation of U.S. patent application Ser. No. 18/155,719, filed Jan. 17, 2023, which claims priority from U.S. Prov. Pat. App. 63/266,897, filed Jan. 18, 2022, and is a divisional of U.S. Design Pat. App. Ser. No. 29/797,856, filed Jul. 2, 2021, all of which are hereby incorporated by reference.

### TECHNICAL FIELD OF THE INVENTION

The present invention relates to hinges, and more particularly to a hinge for enabling installation of a door or half door on a vehicle, such as off road utility vehicles or the like.

### BACKGROUND OF THE INVENTION

Utility vehicles (UTV) or all terrain vehicles (ATV) are often sold without doors, instead employing a mesh-fabric ‘door’ that is removably attached to allow entry and exit from the vehicle, while providing some enclosure when driving to contain any loose items from unintentionally falling out of the vehicle. An example view of such a utility vehicle is shown in FIG. 1, wherein the vehicle 10 has a frame 12 mounting four wheels 14. In the illustrated version, four seats 16 are provided to accommodate driver/passengers 18. A propulsion engine is mounted to the frame at the rear of the illustrated UTV or ATV. A cargo carrying area 22 may be provided in some models. Mesh half ‘doors’ 24 are detachably positioned at lower portions of openings in the frame to allow driver/riders to enter/exit the vehicle easily, but still allow closure of the ‘doors’. The illustrated UTV has four seats and front and rear mesh doors on each side of the vehicle, but two seat/two ‘door’models are also provided.

Many users of such vehicles would prefer to have a more solid door structure, either a partial or half door or a full door to provide further protection and minimize debris, splashes or other incursions from outside the vehicle hitting the driver or passengers or entering the frame interior. As such, add on door kits have been developed, such as shown in FIG. 2, that comprise front and rear doors 26, 28 (driver side doors shown, passenger side doors would typically be mirror images) and attachment hardware for mounting the doors to the frame of the UTV. The attachment hardware might include upper and lower hinge leaf (female) mounts 30, 32, for attachment to the doors, and hinge pin assembly bracket 34 which carries upper and lower bullet hinge pins (male) 36, 38. To mount the doors to the UTV or ATV, the existing mesh ‘door’ is removed, bracket 34 is mounted to the frame of the UTV/ATV, upper and lower hinge pin mounts 30, 32 are mounted to the door(s) at points 40, 42, and the doors are lowered onto the bullet hinge pins. Additional brackets 44 may be provided to assist with securing the bracket 34 to the UTV/ATV's frame.

Unfortunately, the bullet hinge pins will occasionally break as a result of the stresses put on the pins in use, making the door inoperable, so another way to mount doors to UTVs/ATVs that would be more durable and robust is desirable.

### SUMMARY OF THE INVENTION

An object of the invention is to provide a method and apparatus for mounting doors to UTVs/ATVs or other vehicles to replace the stock mesh ‘doors’. An improved bracket mounting a hinged plate is provided for attachment to a door that is to be mounted to the UTV/ATV.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 is a view of a UTV, illustrating the mesh doors;

FIG. 2 shows a prior art bullet hinge mounting solution for installing doors on a UTV;

FIG. 3 is a perspective view of a hinge assembly in accordance with the preferred embodiment;

FIG. 4 is a perspective view of a lower mounting bracket;

FIG. 5 is a view of a striker bracket;

FIG. 6 is a perspective view of a rear lower mounting bracket;

FIG. 7 is a view of a rear striker bracket;

FIG. 8 is a perspective view of an UTV/ATV, for illustration of the process of installing the components of the invention on the UTV/ATV;

FIGS. 9-11 are views illustrating removal of the driver arm rest;

FIGS. 12 and 13 are views illustrating removal of the passenger arm rests;

FIGS. 14-16 illustrate removal of filler panels;

FIGS. 17 and 18 illustrate attachment of the front and rear lower mounting brackets;

FIG. 19 shows the mounting of the hinge assembly to the UTV/ATV;

FIG. 20 illustrates mounting the hinge plate to the lower mounting bracket;

FIG. 21 is a view showing the attachment of the front striker plate;

FIGS. 22-24 show mounting steps for the rear striker plate;

FIG. 25 shows the latching mechanism;

FIGS. 26-27 show attachment of the doors to the hinge assembly and UTV/ATV; and

FIGS. 28 and 29 illustrates details of the rotational mounting of the door mounting plate to the frame mounting plate.

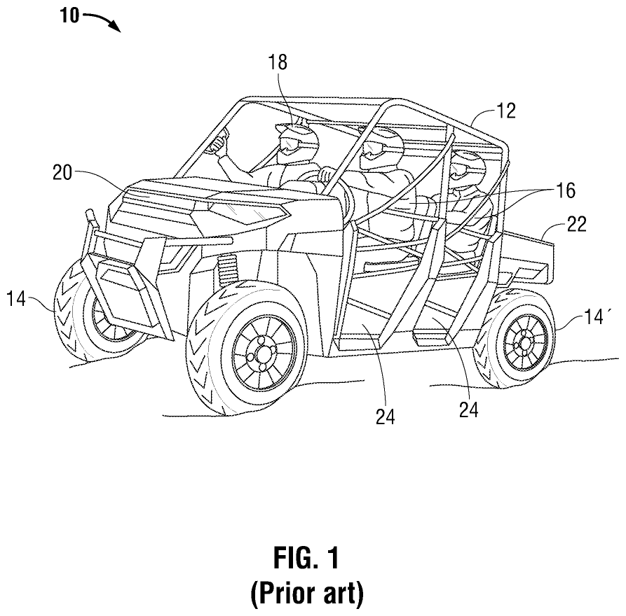

### DETAILED DESCRIPTION OF PREFERRED EMBODIMENTS

A preferred embodiment of the invention uses a hinge assembly and lower bracket members to hingedly mount a door to the frame of an UTV/ATV, for providing an improved door structure to the UTV/ATV over the stock mesh doors. A striker bracket may be provided to engage with a latch member to secure the door when in a closed position.

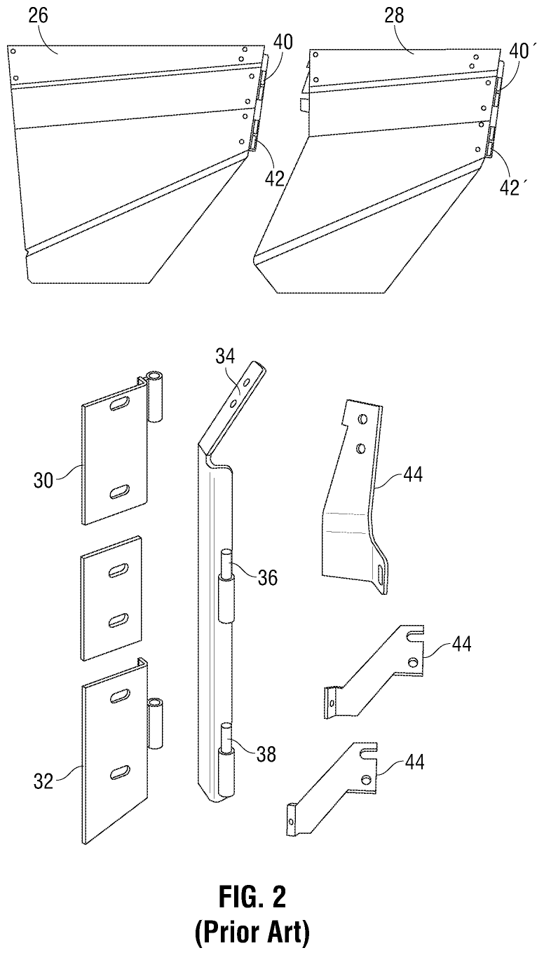

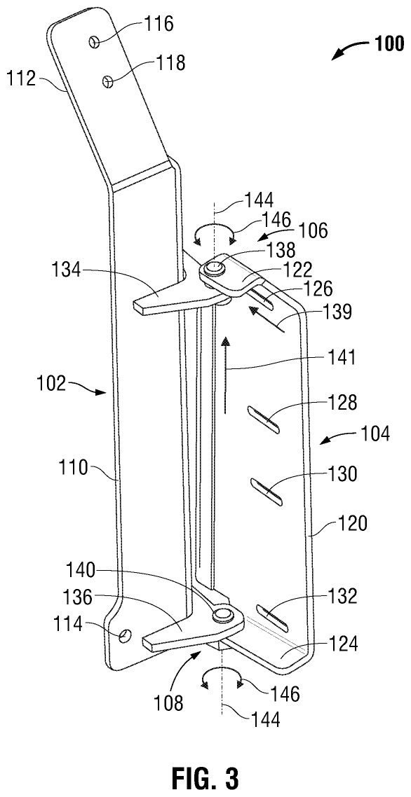

Referring to FIG. 3, a perspective view of a hinge assembly according to the present invention, the assembly 100 comprises an UTV/ATV frame mounting plate 102 and a door mounting plate 104 where the mounting plate 104 is hingedly mounted to plate 102 via upper and lower hinge members 106, 108. Frame mounting plate 102 is formed as an elongate member with a flat longer rectangular flange portion 110 and a shorter upper portion 112 that is angled away from the plane of the portion 110. The lower end of portion 110 flares out slightly and carries fastener mounting hole 114, while the upper portion 112 carries mounting holes 116, 118 in spaced relation to one another.

Door mounting plate 104 is formed as a flat rectangular plate member 120 with upper and lower hinge mounting flange portions 122, 124 extending at 90 degree angles from the main flat portion plate member 120. Mounting slots 126, 128, 130 and 132 are formed in plate member 120 at spaced locations from one another somewhat centrally positioned in the plate member.

Upper and lower mounting flanges 134, 136 connected to flange portion 110 at a somewhat upper position and a lower position, interact with mounting flange portions 122, 124, with hinge pins 138, 140 hingedly mounting the door mounting frame 104 to frame mounting plate 102, via holes or openings formed in flanges 134 and 136, as well as in flange portions 122, 124, allowing rotational movement of the door mounting frame 104 relative to the frame mounting plate on axis 144, as shown by rotational arrows 146. The rotational mounting details are further described in connection with FIG. 28, a partial side view taken in the direction of arrow 139 of FIG. 3 and FIG. 29 a partial view taken in the direction of arrow 141 of FIG. 3.

Hinge pin 138 (and correspondingly 140) passes through holes in flange portion 122 (and 124), held in position by the head of the hinge pin at one end thereof, and by keeper 143, such as an E style clip in the illustrated embodiment, engaged with the end of the pin opposite the head, to keep the pin from sliding out. A bushing 145 lines the openings in flanges 122 and 134, allowing rotational movement of flange 122 relative to flange 134.

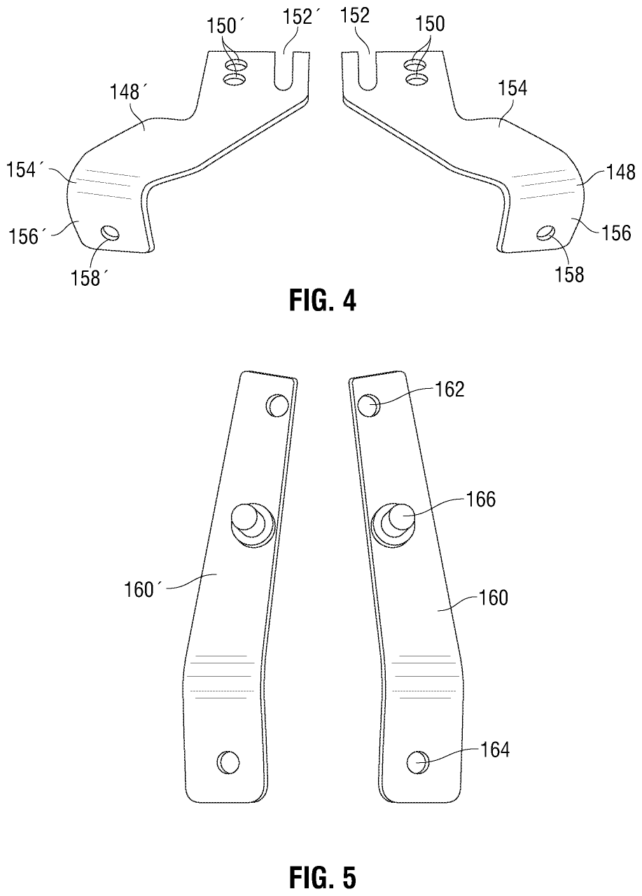

The hinge assembly needs to be secured to the frame of the UTV/ATV, so mounting components are also provided. Referring to FIG. 4, a perspective view of a lower mounting bracket, lower brackets are provided as a left side bracket 148 and right side bracket 148′. The brackets have rear mounting holes 150, 150′ and mounting slots 152, for attachment to the UTV/ATV frame as discussed hereinbelow, and have an angled central region 154 that extends to a mounting plate portion 156 that is oriented to provide a vertically aligned mounting surface. Portion 156 has mounting hole(s) 158 designed to align with fastener mounting hole 114 on the hinge assembly, discussed hereinbelow.

FIG. 5 illustrates an additional mounting component, striker brackets 160 (left side) and 160′ (right side) that have upper and lower mounting holes 162, 164, for attachment to the UTV/ATV frame and carry a striker latch pin 166 (166′) for latching with a corresponding door latch mechanism on the doors. The lower portion of the striker brackets angle slightly to conform to the configuration of the UTV/ATV frame for mounting. The striker brackets are mounted to the frame via fasteners interacting through holes 162, 164.

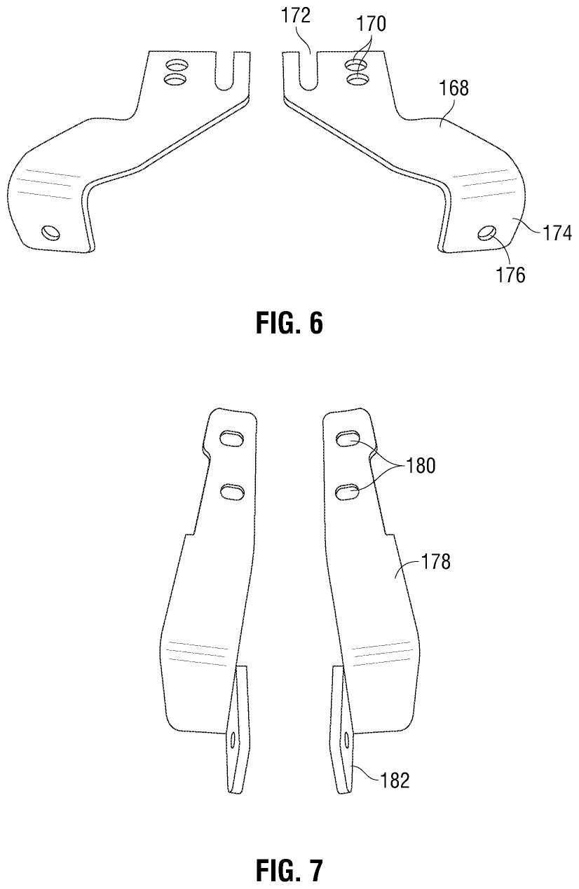

FIG. 6 and FIG. 7 are perspective views of a rear lower mounting bracket 168, with corresponding mounting holes 170, slots 172 and mounting plate portion 174 with fastener hole 176 and an rear striker plate mounting plate portion 178, fastener holes 180 and a striker mounting portion 182, angled to enable mounting of a striker 212 thereon (not shown in FIG. 7, visible in FIG. 24). The lower and striker mounting portions can be suitable, for example, for rear door mounting, while the mounting bracket 148 and striker plate 160 would be used for a front door mounting, in the case of an UTV/ATV having front and rear doors, used when both front and rear mesh ‘doors’ are being replaced.

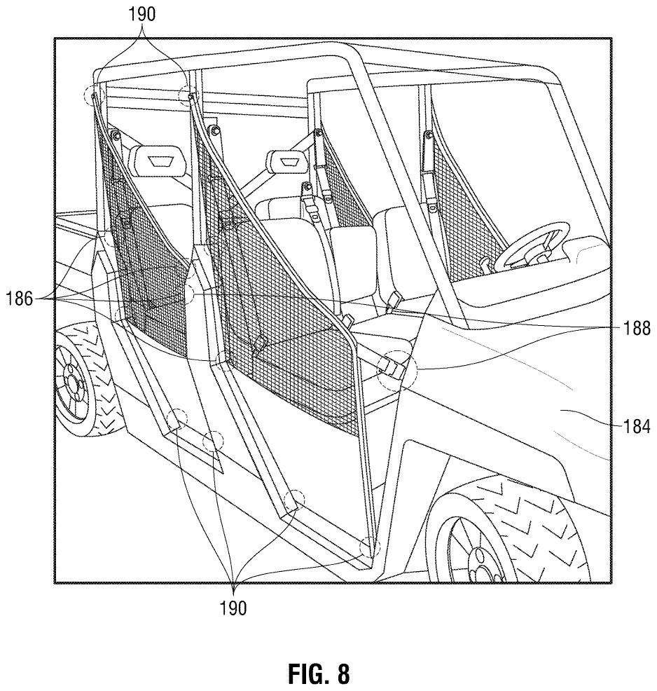

Referring now to FIG. 8, the process of mounting doors to an UTV/ATV in accordance with the invention is discussed. In FIG. 8, a passenger side perspective view of an UTV/ATV 184, a first step is to remove the stock mesh doors by removing the mounting hardware thereof at positions indicated by arrows 186. Also, the front and rear mesh door latches are removed at positions 188. Mounting hardware at positions 190 are also removed, to allow removal of the doors, but at these positions the hardware is then returned into the mounting holes once the mesh doors have been removed, for use later in the process.

Next, the factory arm rests are removed from the UTV/ATV, the front driver arm rest 192 (FIG. 9) is removed by temporarily removing the seat mounting hardware at 194 (FIG. 10), and removing the fasteners at 196 in FIG. 11, allowing the arm rest to be detached from the seat. The fasteners removed at 194 and 196 are then returned to their mounting holes.

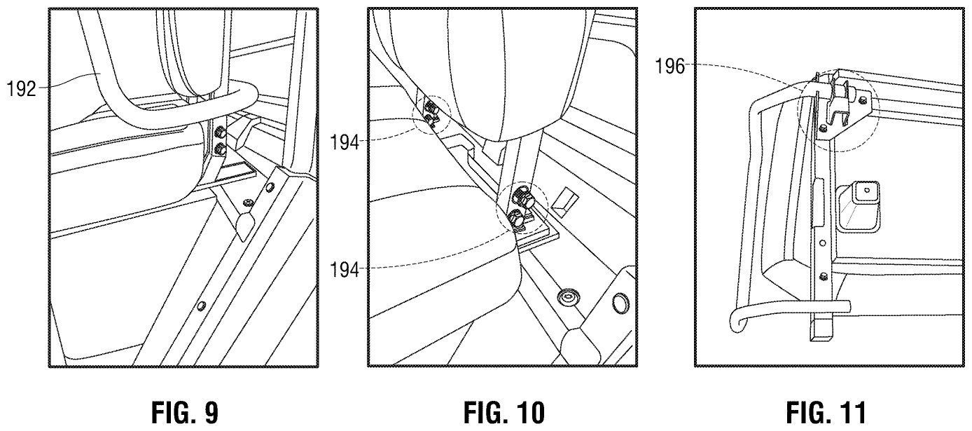

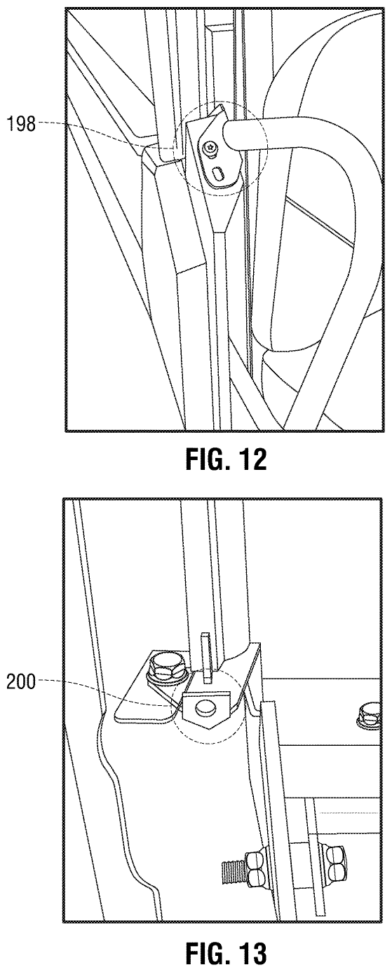

The rear and front passenger arm rests are removed in accordance with FIGS. 12 and 13, wherein upper mounting bolts 198 is removed and then lower mounting bolt 200 is removed, allowing the arm rest to be taken off.

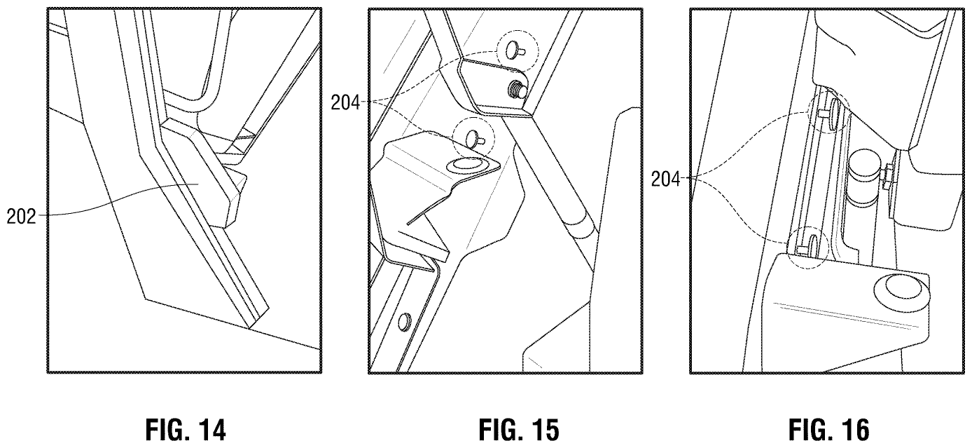

Now, with reference to FIGS. 14-16, filler panels 202 are removed from the front and rear passenger side of the UTV/ATV, and the mounting bolts 204 thereof are returned to their mounting holes.

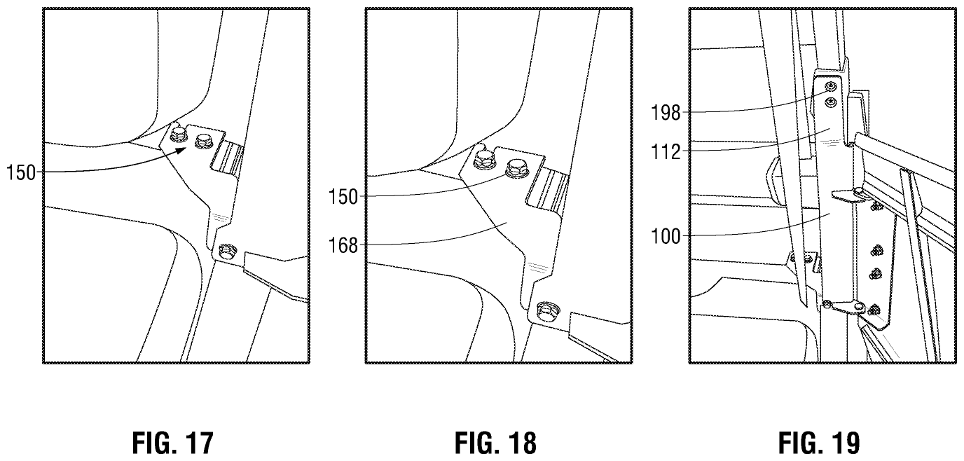

Now, as shown in FIGS. 17 and 18, the front and rear lower brackets 148 and 168 are mounted to the UTV/ATV, both on the driver side and the passenger side. In some cases this mounting may be done using the reserved factory hardware 150 from FIG. 17, to mount the brackets, depending on the specific configuration of the UTV/ATV. The fasteners are just loosely tightened at this time. In the UTV/ATV configuration illustrated, the front most of the 2 mounting holes 150 in the front bracket are used for the mounting fastener, whereas the rear most mounting hole 170 is used for the rear brackets.

Referring now to FIG. 19, the hinge assembly 100 may be mounted to the UTV/ATV frame by using the mounting hardware 198 reserved in the step shown in FIG. 12 to secure the shorter upper portion 112 of frame mounting plate 102 to the UTV/ATV frame via mounting holes 116 and 118 of the hinge assembly. While the mounting hardware 198 is loose, the hinge assembly is positioned such that a gap at the upper and lower portion thereof is about equal, and then the hardware 198 is tightened to secure the hinge assembly to the UTV/ATV. One such hinge assembly is mounted to the UTV/ATV frame for each of the doors.

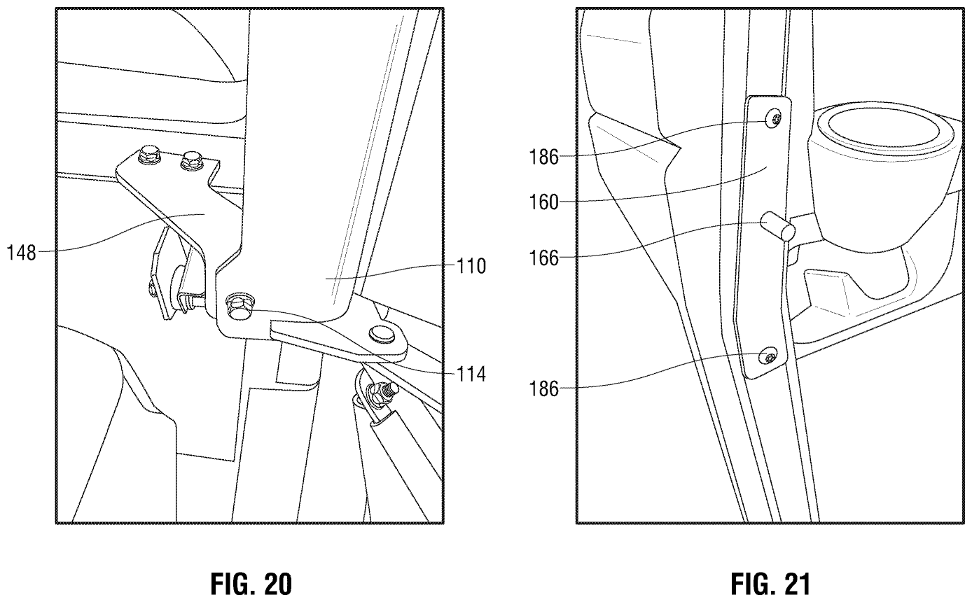

Now, referring to FIG. 20, the is hinge plate is secured to the lower bracket 148 via a fastener that is passed through hole 114 in lower end of the flange portion 110 of the hinge and hole 158 in the lower bracket. This is repeated for the other doors (using hole 176 in rear lower bracket 168, for the rear doors). The hinge assembly is now fully mounted to the UTV/ATV.

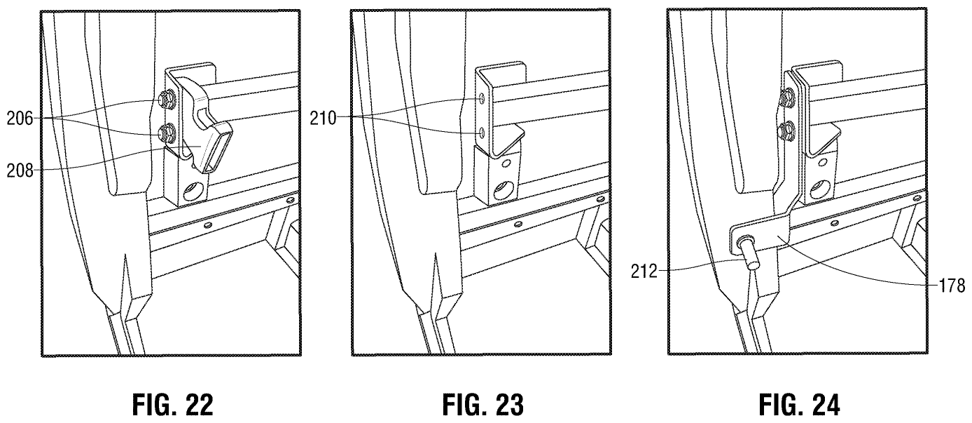

Referring to FIGS. 21-24, the reserved hardware from the front doors indicated at 186 in FIG. 8, is used to mount the front striker brackets 160 to the UTV/ATV frame. For the rear striker brackets, referring to FIG. 22, bolts 206 are removed from the UTV/ATV frame that mount the factory rear latch 208, and exposing fastener holes 210 (FIG. 23). The rear striker bracket is now mounted to the UTV/ATV frame by using fasteners through mounting holes 180 in rear striker plate mounting plate portion 178. Rear striker 212, first mentioned in connection with FIG. 7, is visible in FIG. 24

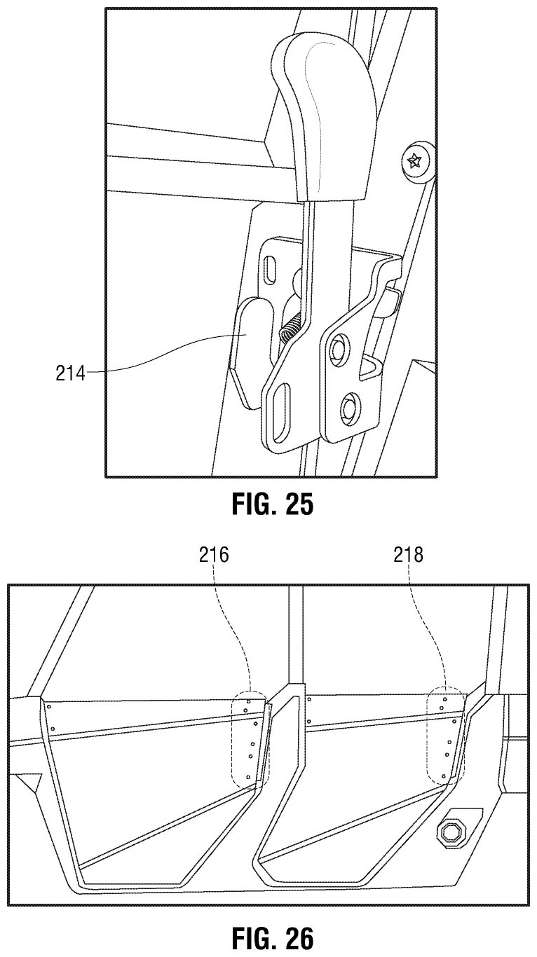

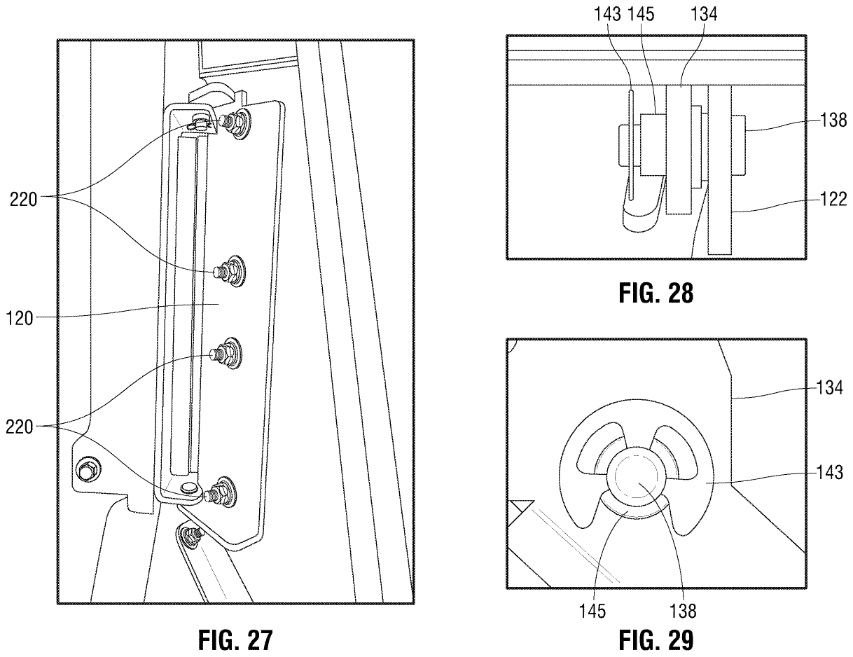

Now the doors can be mounted to the UTV/ATV. Referring to FIGS. 25-27, the doors are positioned at the frame of the UTV/ATV by moving the door into position and engaging the striker with the door latch 214 (FIG. 25). The UTV/ATV will now appear as shown in FIG. 26, with the hinge assembly positioned in the inside faces of the doors at positions indicated at 216, 218. As shown in FIG. 27, plural bolts/fasteners 220 mount the door to mounting plate 104 via mounting slots 126, 128, 130, 132. The door is now securely mounted to the UTV/ATV.

Adjustment of the door to fine tune the alignment thereof is accomplished by loosening the bolts in the mounting slots 126-132, and then repositioning the door. The two Latch Adjustment bolts on the door can be loosened to reposition the latch for adjustment thereof.

Once the doors are attached, the removed seat components may be reinstalled.

Accordingly, an improved method and apparatus for mounting doors to an UTV/ATV has been shown and described.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A hinge system for mounting a door to an UTV or ATV, comprising:
a first mounting flange;
a second mounting flange, wherein a plane of said first mounting flange is positioned at an angle of a plane of said second mounting flange, said angle chosen to conform said first mounting flange to substantially fit a first surface of a frame of the UTV or ATV, while said second mounting flange fits to a second surface of the frame of the UTV or ATV;
a door mounting plate, hingedly engaged with at least one of said first and second mounting flanges,
wherein said door mounting plate is engaged via a hinge pin to at least one of said first mounting flange or said second mounting flange and the door mounting plate is further adapted for mounting to the door for hingedly attaching said door to said UTV or ATV.

2. The hinge system according to claim 1, further comprising,
said second mounting flange comprises:
an upper mounting flange attached to the second mounting flange and a lower mounting flange attached to the second mounting flange, spaced a distance from one another along an extent of the second mounting flange;
said door mounting plate comprises:
a upper flange mounted to said door mounting plate,
a lower flange mounted to said door mounting plate,
said upper and lower flanges mounted to said door mounting plate spaced a distance apart from one another along an extent of said door mounting plate,
the spacing of said upper and lower flanges mounted to said door mounting plate corresponding to the spacing of said upper mounting flange and said lower mounting flange on said frame plate such that door plate and frame plate upper mounting flange are in close relation and said door plate and frame plate lower mounting flange are in close relation when said frame mounting flange plate and said door mounting plate are positioned next to each other.

3. The hinge system according to claim 2, further comprising:
said door plate upper flange portion, said door plate lower flange portion said frame plate upper mounting flange and said frame plate lower mounting flange have hinge openings defined therein, wherein a first hinge pin is received in the openings in said door plate upper flange portion and said frame plate upper mounting flange and a second hinge pin is received in openings in the door plate lower mounting flange, and said frame plate lower mounting flange, whereby a hinge mechanism is formed.

4. The hinge system according to claim 3, further comprising a clip member for securing one of said first and second hinge pins in position when received in said openings.

5. The hinge system according to claim 3, further comprising a bushing positioned inside at least one of said openings in said door plate upper mounting flange, said frame plate upper mounting flange and said openings door plate lower mounting flange and said frame plate lower mounting flange.

6. The hinge system according to claim 1, further comprising a striker bracket adapted to mount to the frame of the UTV or ATV, said bracket having a striker member for engagement with the door when the door is closed.

7. The hinge system according to claim 1, wherein said panel door comprises a full panel door.

8. The hinge system according to claim 1, wherein said panel door comprises a partial panel door.

9. A method for replacing a mesh door of an UTV or ATV with a panel door, comprising the steps of:
removing the mesh door;
mounting a lower door attachment bracket to a frame of the UTV or ATV;
attaching a hinge member to the UTV or ATV, said hinge member having a first mounting flange portion and a second mounting flange portion, said first and second mounting flange portions being at an angle to one another, said angle chosen so that one of said first and second mounting flange portions attaches to a first surface of the frame of the UTV or ATV while the other of said first and second mounting flange portions attaches to a second surface of the frame of the UTV or ATV, attaching said first and second mounting flange portions to the frame of the UTV or ATV and attaching one of said first and second mounting flange portions to the lower door attachment bracket; and
said hinge member further having a door attachment member in hinged relation to said first and second mounting flange portions, and attaching the panel door to the hinge member, thereby hingedly mounting said panel door to the UTV or ATV.

10. The method according to claim 9, further comprising:
attaching a striker bracket to the frame of the UTV or ATV, said bracket having a striker member for engagement with the door when the door is closed.

11. The method according to claim 9, further comprising,
said second mounting flange comprises:
an upper mounting flange attached to the second mounting flange and a lower mounting flange attached to the second mounting flange, spaced a distance from one another along an extent of the second mounting flange;
said door mounting plate comprises:
a upper flange mounted to said door mounting plate,
a lower flange mounted to said door mounting plate,
said upper and lower flanges mounted to said door mounting plate spaced a distance apart from one another along an extent of said door mounting plate,
the spacing of said upper and lower flanges mounted to said door mounting plate corresponding to the spacing of said upper mounting flange and said lower mounting flange on said frame plate such that door plate and frame plate upper mounting flange are in close relation and said door plate and frame plate lower mounting flange are in close relation when said frame mounting flange plate and said door mounting plate are positioned next to each other.

12. The method according to claim 9, further comprising:
said door plate upper flange portion, said door plate lower flange portion said frame plate upper mounting flange and said frame plate lower mounting flange have hinge openings defined therein, wherein a first hinge pin is received in the openings in said door plate upper flange portion and said frame plate upper mounting flange and a second hinge pin is received in openings in the door plate lower mounting flange, and said frame plate lower mounting flange, whereby a hinge mechanism is formed.

13. The method according to claim 12, further comprising providing a clip member for securing one of said first and second hinge pins in position when received in said openings.

14. The method according to claim 12, further comprising positioning a bushing inside at least one of said openings in said door plate upper mounting flange, said frame plate upper mounting flange and said openings door plate lower mounting flange and said frame plate lower mounting flange.

15. The method according to claim 9, wherein said panel door comprises a full panel door.

16. The method according to claim 9, wherein said panel door comprises a partial panel door.

17. The method according to claim 9, wherein the method is performed for two doors of the UTV or ATV.

18. The method according to claim 9, wherein the method is performed for four doors of the UTV or ATV.
